(19) United States
(12) Patent Application Publication
(10) Pub. No.: US 2025/0051684 A1
(43) Pub. Date: Feb. 13, 2025

(54) ADDITIVES AND USE THEREOF IN CORN FERMENTATION PROCESS STREAM AND OTHER BIOPROCESSES

(71) Applicant: BASF SE, Ludwigshafen Am Rhein (DE)

(72) Inventors: Joseph P. BORST, Wyandotte, MI (US); Matthew Gerard LYON, Wyandotte, MI (US); Padma P. VARANASI, Wyandotte, MI (US)

(21) Appl. No.: 18/720,740

(22) PCT Filed: Dec. 20, 2022
(86) PCT No.: PCT/EP22/86825

§ 371 Date: Jun. 17, 2024

Related U.S. Application Data
(60) Provisional application No. 63/296,230, filed on Jan. 4, 2022.

(51) Int. Cl. C11B 3/16; B01D 17/02; B01D 17/04; B01D 21/26; C12F 3/10

(52) U.S. Cl. CPC C11B 3/16; B01D 17/0217; B01D 17/047; B01D 21/262; C12F 3/10

(57) ABSTRACT

Described herein is a composition including at least one product from a corn fermentation process stream, and at least one first additive including at least one anionic surfactant of formula (I), and/or at least one polyethoxylated sorbitan ester of general formula (II). Also described herein is a method of increasing the amount of corn oil recovered from at least one product from a corn fermentation process stream. Also described herein is a method of using at least one first additive for increasing recovery of corn oil from at least one product obtained from a corn fermentation process stream.

### FIELD OF THE INVENTION

The present invention relates to a composition comprising at least one product from a corn fermentation process stream, and at least one first additive comprising at least one anionic surfactant of formula (I), and/or at least one polyethoxylated sorbitan ester of general formula (II). The present invention also relates to a method of increasing the amount of corn oil recovered from at least one product from a corn fermentation process stream. The present invention further relates to the use of at least one first additive for increasing recovery of corn oil from at least one product obtained from a corn fermentation process stream.

### BACKGROUND OF THE INVENTION

Corn bioethanol producers derive value from their crops in a variety of ways. The ethanol produced from corn is the major source of income, but other revenue streams exist. For example, other products or coproducts of ethanol production, such as dried distiller's grains and corn oil, are produced. A major market for distiller's corn oil is feed and fuel production, such as biodiesel production. Animal feed can be prepared from dried distiller's grains with solubles (DDGS).

Sine there is a need to maximize profitability of the plant, especially considering low ethanol prices, corn bioethanol producers actively seek to increase the yield of distillers' corn oil (DCO) produced in the dry grind ethanol process through the use of emulsion breakers otherwise known as corn oil recovery aids. Typically, maximizing the yield of corn oil often employs the use of silica particles, which can be hydrophilic or hydrophobically modified, which are dispersed in one or more surfactants. However, the abrasive nature of the silica particles causes undesired wear and tear on centrifuges.

Thus, it is an object of the present invention to provide a composition having reduced or no silica particles for enhancing corn oil recovery in a corn ethanol process.

Another object of the present invention is to provide a method of increasing the amount of corn oil in a corn ethanol process.

### SUMMARY OF THE INVENTION

Surprisingly, it has been found that the composition of the present invention has the ability to provide enhanced corn oil recovery without the use of silica particles. Furthermore, it has also been found that the potential reduction of or elimination of silica particles, for enhancing the corn oil recovery, improved handling of the emulsion breaker and reduced wear and tear on expensive centrifuge equipment.

Thus, in one aspect, the presently claimed invention is directed to a composition comprising
A. at least one product from a corn fermentation process stream; and
B. at least one first additive comprising:
   i. at least one anionic surfactant of formula (I)

R₁O(D)ₚ(E)_{q}SO₃⁻M⁺ (I)
wherein
R₁ is linear or branched, unsubstituted C₆-C₂₂ alkyl,
D denotes CH(CH₃)—CH₂—O—,
E denotes CH₂—CH₂—O—
p is an integer in the range from 0 to 10,
q is an integer in the range from 0 to 35, and
M is H or alkali metal or ammonium cation; and/or
ii. at least one polyethoxylated sorbitan ester of general formula (II)

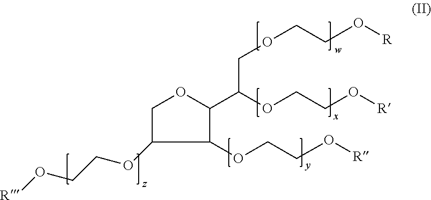

wherein
R, R′, R″, R″′ are each independently H or COR₂ with a proviso that at least one of R, R′, R″ and R″′ is not H,
R₂ is linear or branched, substituted or unsubstituted C₆ to C₂₀ alkyl or alkenyl, and
w, x, y, z is independently an integer in the range of 0 to 30, wherein the sum of w+x+y+z is at least 5.

In another aspect, the presently claimed invention is directed to a method of increasing the amount of corn oil recovered from at least one product from a corn fermentation process stream comprising the steps of.
a. the at least one product from the corn fermentation process stream is contacted with a first additive as defined in any one of claims 1 to 12 to produce a mixture;
b. the mixture obtained in step (a) is centrifuged; and
c. corn oil is recovered from the mixture; wherein the amount of oil recovered from the mixture is greater than the amount of corn oil that would be recovered using the same process without inclusion of the first additive.

In yet another aspect, the presently claimed invention is directed to the use of at least one first additive as defined above for increasing recovery of corn oil from at least one product obtained from a corn fermentation process stream.

### DETAILED DESCRIPTION OF THE INVENTION

Before the present compositions and formulations of the invention are described, it is to be under-stood that this invention is not limited to particular compositions and formulations described, since such compositions and formulation may, of course, vary. It is also to be understood that the terminology used herein is not intended to be limiting, since the scope of the presently claimed invention will be limited only by the appended claims. If hereinafter a group is defined to comprise at least a certain number of embodiments, this is meant to also encompass a group which preferably consists of these embodiments only.

Further-more, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention de-scribed herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless other-wise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “a preferred embodiment” means that a particular feature, structure or characteristic described in connection with the embodiment is included in at least one embodiment of the presently claimed invention. Thus, appearances of the phrases “in one embodiment” or “in a preferred embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to a composition comprising
A. at least one product from a corn fermentation process stream; and
B. at least one first additive comprising:
   i. at least one anionic surfactant of formula (I)

R₁O(D)ₚ(E)_{q}SO₃⁻M⁺ (I)
wherein
R₁ is linear or branched, unsubstituted C₆-C₂₂ alkyl,
D denotes CH(CH₃)—CH₂—O—,
E denotes CH₂—CH₂—O—
p is an integer in the range from 0 to 10,
q is an integer in the range from 0 to 35, and
M is H or alkali metal or ammonium cation; and/or
ii. at least one polyethoxylated sorbitan ester of general formula (II)

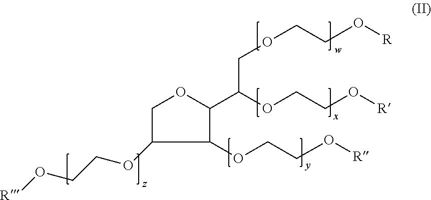

wherein
R, R′, R″, R″′ are each independently H or COR₂ with a proviso that at least one of R, R′, R″ and R″′ is not H,
R₂ is linear or branched, substituted or unsubstituted C₆ to C₂₀ alkyl or alkenyl, and
w, x, y, z is independently an integer in the range of 0 to 30, wherein the sum of w+x+y+z is at least 5.

In an embodiment, the at least one product from a corn fermentation process stream is selected from meal (after the corn has been milled), beer, stillage, such as whole stillage or thin stillage, wet cake (distillers wet grain), distillers dried grain, distillers dried grain with solubles and corn syrup.

In a preferred embodiment, the at least one product from a corn fermentation process stream is selected from beer, whole stillage, thin stillage, and corn syrup.

In an embodiment, the at least one first additive comprises at least one anionic surfactant of formula (I) and/or at least one polyethoxylated sorbitan ester of general formula (II).

Anionic Surfactant of Formula (I):

R₁O(D)ₚ(E)_{q}SO₃⁻M⁺ (I)
wherein
R₁ is linear or branched, unsubstituted C₆-C₂₂ alkyl,
D denotes CH(CH₃)—CH₂—O—,
E denotes CH₂—CH₂—O—
p is an integer in the range from 0 to 10,
q is an integer in the range from 0 to 35, and
M is H or alkali metal or ammonium cation

In an embodiment, R₁ is selected from n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, and 2-ethyl hexyl.

In an embodiment, the alkali metal is selected from sodium and potassium. In a preferred embodiment, the alkali metal is sodium.

In an embodiment, the composition comprises at least one anionic surfactant of formula (I), wherein R₁ denotes linear or branched, unsubstituted C₈-C₂₂ alkyl, p is an integer in the range of 1 to 10, q is an integer in the range of 0.1 to 5, and M is H or alkali metal or ammonium cation.

In an embodiment, the composition comprises at least one anionic surfactant of formula (I), wherein R₁ denotes linear or branched, unsubstituted C₁₆ to C₁₈ alkyl, p is 7, q is 0.1, and M is alkali metal.

In an embodiment, the composition comprises at least one anionic surfactant of formula (I), wherein R₁ denotes linear or branched, unsubstituted C₈-C₁₅ alkyl, p is 0, q is an integer in the range of 0.1 to 12, and M is H or alkali metal or ammonium cation.

In an embodiment, the composition comprises at least one anionic surfactant of formula (I), wherein R₁ denotes linear or branched, unsubstituted C₁₂ alkyl, p is 0, q is 2, and M is alkali metal.

In an embodiment, the composition comprises at least one anionic surfactant of formula (I), wherein R₁ denotes linear or branched, unsubstituted C₁₂ alkyl, p is 0, q is 12, and M is alkali metal.

In an embodiment, the composition comprises at least one anionic surfactant of formula (I), wherein R₁ denotes linear, unsubstituted C₁₂ alkyl, p is 0, q is 0, and M is alkali metal.

Polyethoxylated sorbitan ester of general formula (II):

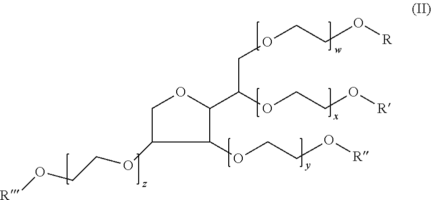

wherein
R, R′, R″, R″′ are each independently H or COR₂ with a proviso that at least one of R, R′, R″ and R″′ is not H,
R₂ is linear or branched, substituted or unsubstituted C₆ to C₂₀ alkyl or alkenyl, and
w, x, y, z is independently an integer in the range of 0 to 30, wherein the sum of w+x+y+z is at least 5.

In an embodiment, the sum of w+x+y+z is 20.

In an embodiment, the at least one polyethoxylated sorbitan ester of general formula (II) is selected from sorbitan monooleate ethoxylate, sorbitan tristearate ethoxylate, and mixtures thereof.

### Second Additive:

The composition of the present invention further comprises at least one second additive comprising at least one anionic surfactant, other than anionic surfactant of formula (I), and/or at least one non-ionic surfactant.

The at least one anionic surfactant, other than anionic surfactant of formula (I), is selected from alkylbenzene sulfonates, alkylphenol ether sulfates, alkyl sulfates, carboxylates, napthalene sulfonates, olefin sulfonates, petroleum sulfonates, phosphates, phospholipids, soap, soap substitute, sulfates, ethoxylated sulfates, sulfonates, ammonium lauryl sulfate, ammonium perfluorononanoate, anionic derivatives of alkylpolyglucosides, anionic derivatives of fatty alcohols, chlorosulfolipid, sulfosuccinates, alkali metal salts of alkyl sulfosuccinates, such as dioctyl sulfosuccinate (Docusate), sodium dihexyl sulfosuccinate esters (Cola® Wet MA-80), sodium alkylsulfosuccinates, sodium sulfosuccinate esters, disodium cocoamphodiacetate, magnesium laureth sulfate, salts of perfluorobutanesulfonic acid, salts of perfluorononanoic acid, salts of perfluorooctanesulfonic acid, salts of perfluorooctanoic acid, phosphate esters, phosphate esters of polyalkyleneoxides, phosphate esters of sodium alkylsulfosuccinates, polyalkyleneoxides, potassium lauryl sulfate, sodium alkyl sulfate, sodium dodecyl sulfate (SDS), sodium laurate, sodium laureth sulfate (SLES), sodium lauryl sulfate (SLS), sodium lauroyl sarcosinate, sodium myreth sulfate, sodium nonanoyloxybenzenesulfonate, sodium pareth sulfate, sodium stearate, sulfolipid, sulfated alkanolamides, sulfated esters, sulfated natural oils and fats, sulfates, sulfonates, and mixtures thereof.

In a preferred embodiment, the at least one anionic surfactant, other than anionic surfactant of formula (I), is selected from alkylbenzene sulfonates, alkylphenol ether sulfates, alkyl sulfates, carboxylates, napthalene sulfonates, olefin sulfonates, petroleum sulfonates, phosphates, phospholipid, soap, soap substitute, sulfates, sulfonates, and mixtures thereof.

The at least one non-ionic surfactant is may be a surfactant that is conventionally used for oil removal in a corn to ethanol process stream.

In an embodiment, the at least one non-ionic surfactant is selected from alkylphenol ethoxylate formaldehyde resins, alkyl phenol resins, alcohol alkoxylates, alkylpolyalkyleneoxides, alkylpolyglucosides, block copolymers of ethylene oxide and propylene oxide or butylene oxide and mixtures thereof, carboxylic amides, carboxylic esters, castor oil ethoxylates, fatty alcohols, glycol esters of fatty acids, monoalkanolamine condensates, ethoxylates, polyethylene glycol esters, polyoxyethylenes, polyoxyethylene fatty acid amides, polyoxyethylene sorbitan esters, fatty esters of alkoxylated glycerols (such as those described in U.S. Pat. No. 9,828,568, the teachings and contents of which are hereby incorporated by reference), alkoxylated plant oils, alkoxylated plant fats, alkoxylated animal oils, alkoxylated animal fats, alkyl polyglycoside, anhydrosorbitol ester and ethoxylated derivatives, polyethylene glycol hexadecyl ether (Cetomacrogol 1000), cetostearyl alcohol, cetyl alcohol, cocamide diethanolamine, cocamide methanolamine, decyl glucoside, decyl polyglucose, ethoxylated aliphatic alcohol, glycerol monostearate, octylphenoxypolyethoxyethanol (IGEPAL CA-630), polyethylene glycol ether of isocetyl alcohol (Isoceteth-20), lauryl glucoside, maltosides, monolaurin, mycosubtilin, octylphenoxypolyethoxyethanol (Nonidet P-40), nonoxynols, such as Nonoxynol-9, nonyl phenoxypolythoxyethanol (NP-40), octaethylene glycol monododecyl ether, N-octyl beta-D-thioglucopyranoside, octyl glucoside, oleyl alcohol, PEG-10 sunflower glycerides, pentaethylene glycol monododecyl ether, polidocanol, poloxamer, including Poloxamer 407, polyethoxylated tallow amine, polyglycerol polyricinoleate, ethoxylated soybean oil (such as used in Agnique® SBO 10 and Agnique @SBO 30 (both from BASF Corporation)), sorbitan, sorbitan monolaurate, sorbitan monostearate, sorbitan tristearate, stearyl alcohol, surfactin, polyoxyethylene octyl phenyl ether (Triton X-100), and mixtures thereof.

In a preferred embodiment, the at least one non-ionic surfactant is selected from the group of alkyl phenol resins, alkylphenol ethoxylate formaldehyde resins, alcohol alkoxylates, alkylpolyalkyleneoxides, alkylpolyglucosides, block copolymers of ethylene oxide and propylene oxide, block copolymers of ethylene oxide and butylene oxide, carboxylic amides, carboxylic esters, castor oil ethoxylates, fatty alcohols, glycol esters of fatty acids, sorbitan esters, monoalkanolamine condensates, polyethylene glycol esters, polyoxyethylenes, polyoxyethylene fatty acid amides, fatty esters of alkoxylated glycerols, alkoxylated plant oils, alkoxylated plant fats, alkoxylated animal oils, alkoxylated animal fats, and mixtures thereof.

In a more preferred embodiment, the at least one non-ionic surfactant is selected from alkylphenol ethoxylate formaldehyde resins, castor oil ethoxylates, sorbitan esters, and mixtures thereof.

The alkylphenol ethoxylate formaldehyde resins is selected from butylphenol ethoxylate formadehyde resin, amylphenol ethoxylate formadehyde resin, octylphenol ethoxylate formaldehyde resin, and nonylphenol ethoxylate formaldehyde resin. In a preferred embodiment, the alkylphenol ethoxylate formaldehyde resins is selected from nonylphenol ethoxylate formaldehyde resin and amylphenol ethoxylate formaldehyde resin.

The sorbitan esters is selected from sorbitan monolaurate, sorbitan monostearate, sorbitan tristearate, and mixtures thereof.

In an embodiment, the composition of the present invention further comprises hydrophobic silica particles, hydrophilic silica particles, and mixtures thereof.

In an embodiment, the at least one first additive is present in an amount of 10 ppm to 2000 ppm by weight, based on the total weight of the composition, preferably the at least one first additive is present in an amount of 20 ppm to 1500 ppm by weight, based on the total weight of the composition.

The at least one anionic surfactant of formula (I) is present in an amount of 30 ppm to 1000 ppm by weight, based on the total weight of the at least one first additive, preferably the at least one anionic surfactant of formula (I) is present in an amount of 50 ppm to 900 ppm by weight, based on the total weight of the at least one first additive, more preferably the at least one anionic surfactant of formula (I) is present in an amount of 100 ppm to 800 ppm by weight, based on the total weight of the at least one first additive, and most preferably the at least one anionic surfactant of formula (I) is present in an amount of 100 ppm to 500 ppm by weight, based on the total weight of the at least one first additive.

In an embodiment, the weight ratio of the at least one anionic surfactant of formula (I) to the at least one polyethoxylated sorbitan ester of general formula (II) is in a range of 0.2:10 to 10:0.2, preferably the weight ratio of the at least one anionic surfactant of formula (I) to the at least one polyethoxylated sorbitan ester of general formula (II) is in a range from 0.5:5 to 5:0.5.

The weight ratio of the at least one first additive to the at least one second additive is in a range from 0.5:10 to 10:0.5.

In another aspect, the presently claimed invention is directed to a method of increasing the amount of corn oil recovered from at least one product from a corn fermentation process stream comprising the steps of:
a. the at least one product from the corn fermentation process stream is contacted with a first additive as defined above to produce a mixture;
b. the mixture obtained in step (a) is centrifuged; and
c. corn oil is recovered from the mixture; wherein the amount of oil recovered from the mixture is greater than the amount of corn oil that would be recovered using the same process without inclusion of the first additive.

In an embodiment, the at least one first additive is added in the step (a) to obtain Hydrophilic-Lipophilic Difference (HLD) values in the range of −2 to 2, preferably −1.5 to 2 or −1.5 to 1.5, more preferably −1 to 1.5 or −1 to 1, most preferably −0.9 to 1 or −0.9 to 0.9 or −0.9 to 0.8 or −0.9 to 0.7 or −0.9 to 0.6 or −0.8 to 1 or −0.8 to 0.9 or −0.8 to 0.8 or −0.8 to 0.7 or −0.8 to 0.6 or −0.7 to 1 or −0.7 to 0.9 or −0.7 to 0.8 or −0.7 to 0.7 or −0.7 to 0.6 or −0.6 to 1 or −0.6 to 0.9 or −0.6 to 0.8 or −0.6 to 0.7 or −0.6 to 0.6 or −0.5 to 1 or −0.5 to 0.9 or −0.5 to 0.8 or −0.5 to 0.7 or −0.5 to 0.6. The HLD values are dependent on the system. The main system will be the temperature of centrifugation, the mixture of corn oils, and salinity of the water phase. Finally, the surfactant will also affect the HLD value. The HLD values cannot be controlled with the temperature of centrifugation, the mixture of corn oils, and salinity of the water phase but can be controlled by choosing the right surfactant (getting it as close to 0 as possible).

In an embodiment, step (a) further comprises second additive as defined above.

In an embodiment, the at least one product from a corn fermentation process stream is selected from meal (after the corn has been milled), beer, stillage, such as whole stillage or thin stillage, wet cake (distillers wet grain), distillers dried grain, distillers dried grain with solubles and corn syrup.

In a preferred embodiment, the at least one product from a corn fermentation process stream is selected from beer, whole stillage, thin stillage, and corn syrup.

In an embodiment, the method as defined above further comprising hydrophobic silica particles, hydrophilic silica particles, and mixtures thereof.

In another aspect, the presently claimed invention is directed to the use of at least one first additive as defined above for increasing recovery of corn oil from at least one product obtained from a corn fermentation process stream.

The at least one first additive is added to obtain Hydrophilic-Lipophilic Difference values in the range of −2 to 2, preferably −1.5 to 2 or −1.5 to 1.5, more preferably −1 to 1.5 or −1 to 1, most preferably −0.9 to 1 or −0.9 to 0.9 or −0.9 to 0.8 or −0.9 to 0.7 or −0.9 to 0.6 or −0.8 to 1 or −0.8 to 0.9 or −0.8 to 0.8 or −0.8 to 0.7 or −0.8 to 0.6 or −0.7 to 1 or −0.7 to 0.9 or −0.7 to 0.8 or −0.7 to 0.7 or −0.7 to 0.6 or −0.6 to 1 or −0.6 to 0.9 or −0.6 to 0.8 or −0.6 to 0.7 or −0.6 to 0.6 or −0.5 to 1 or −0.5 to 0.9 or −0.5 to 0.8 or −0.5 to 0.7 or −0.5 to 0.6.

In an embodiment, the presently claimed invention is directed to the further use of at least one second additive as defined above for increasing recovery of corn oil from at least one product obtained from a corn fermentation process stream.

In an embodiment, the presently claimed invention is directed to the further use of hydrophobic silica particles, hydrophilic silica particles, and mixtures thereof.

In an embodiment, the at least one product from a corn fermentation process stream is selected from meal (after the corn has been milled), beer, stillage, such as whole stillage or thin stillage, wet cake (distillers wet grain), distillers dried grain, distillers dried grain with solubles and corn syrup.

In a preferred embodiment, the at least one product from a corn fermentation process stream is selected from beer, whole stillage, thin stillage, and corn syrup.

The presently claimed invention offers one or more of following advantages:
1. The use of at least one first additive with reduced or no silica particles enhances corn oil recovery in a corn ethanol process.
2. The increase in the yield of corn oil in the corn ethanol process increases the profitability of the corn ethanol plant.
3. Further, due to the reduction of or elimination of silica particles improves handling of the emulsion breaker and also reduce wear and tear on expensive centrifuge equipment.

In the following, specific embodiments of the presently claimed invention are described:

1. A composition comprising
A. at least one product from a corn fermentation process stream; and
B. at least one first additive comprising:
   i. at least one anionic surfactant of formula (I)

R₁O(D)ₚ(E)_{q}SO₃⁻M⁺ (I)
wherein
R₁ is linear or branched, unsubstituted C₆-C₂₂ alkyl,
D denotes CH(CH₃)—CH₂—O—,
E denotes CH₂—CH₂—O—
p is an integer in the range from 0 to 10,
q is an integer in the range from 0 to 35, and
M is H or alkali metal or ammonium cation; and/or
ii. at least one polyethoxylated sorbitan ester of general formula (II)

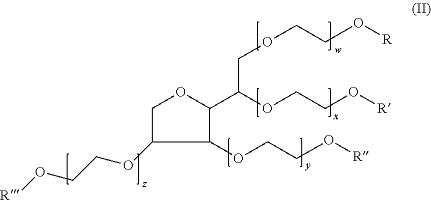

wherein
R, R′, R″, R″′ are each independently H or COR₂ with a proviso that at least one of R, R′, R″ and R″′ is not H,
R₂ is linear or branched, substituted or unsubstituted C₆ to C₂₀ alkyl or alkenyl, and
w, x, y, z is independently an integer in the range of 0 to 30, wherein the sum of w+x+y+z is at least 5.

2. The composition according to embodiment 1, wherein the at least one product from a corn fermentation process stream is selected from beer, whole stillage, thin stillage, and corn syrup.

3. The composition according to one or more of embodiments 1 and 2, wherein R₁ is selected from n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, and 2-ethyl hexyl.

4. The composition according to one or more of embodiments 1 to 3, wherein R₁ denotes linear or branched, unsubstituted C₈-C₂₂ alkyl, p is an integer in the range of 1 to 10, q is an integer in the range of 0.1 to 5, and M is H or alkali metal or ammonium cation.

5. The composition according to one or more of embodiments 1 to 4, wherein R₁ denotes linear or branched, unsubstituted C₈-C₁₅ alkyl, p is 0, q is an integer in the range of 0.1 to 12, and M is H or alkali metal or ammonium cation.

6. The composition according to one or more of embodiments 1 to 5, wherein R₁ denotes linear or branched, unsubstituted C₁₂ alkyl, p is 0, q is 2, and M is alkali metal.

7. The composition according to one or more of embodiments 1 to 6, wherein R₁ denotes linear or branched, unsubstituted C₁₂ alkyl, p is 0, q is 12, and M is alkali metal.

8. The composition according to one or more of embodiments 1 to 7, wherein R₁ denotes linear, unsubstituted C₁₂ alkyl, p is 0, q is 0, and M is alkali metal.

9. The composition according to one or more of embodiments 1 to 8, wherein the alkali metal is selected from sodium and potassium.

10. The composition according to one or more of embodiments 1 to 9, wherein the alkali metal is sodium.

11. The composition according to one or more of embodiments 1 to 10, wherein the at least one polyethoxylated sorbitan ester of general formula (II) is selected from sorbitan monooleate ethoxylate, sorbitan tristearate ethoxylate, and mixtures thereof.

12. The composition according to one or more of embodiments 1 to 11, wherein the sum of w+x+y+z is 20.

13. The composition according to one or more of embodiments 1 to 12, further comprises at least one second additive comprising at least one anionic surfactant, other than anionic surfactant of formula (I), and/or at least one non-ionic surfactant.

14. The composition according to embodiment 13, wherein the at least one anionic surfactant, other than anionic surfactant of formula (I), is selected from alkylbenzene sulfonates, alkylphenol ether sulfates, alkyl sulfates, carboxylates, napthalene sulfonates, olefin sulfonates, petroleum sulfonates, phosphates, phospholipid, soap, soap substitute, sulfates, sulfonates, and mixtures thereof.

15. The composition according to embodiment 13, wherein the at least one non-ionic surfactant is selected from the group of alkyl phenol resins, alkylphenol ethoxylate formaldehyde resins, alcohol alkoxylates, alkylpolyalkyleneoxides, alkylpolyglucosides, block copolymers of ethylene oxide and propylene oxide, block copolymers of ethylene oxide and butylene oxide, carboxylic amides, carboxylic esters, castor oil ethoxylates, fatty alcohols, glycol esters of fatty acids, sorbitan esters, monoalkanolamine condensates, polyethylene glycol esters, polyoxyethylenes, polyoxyethylene fatty acid amides, fatty esters of alkoxylated glycerols, alkoxylated plant oils, alkoxylated plant fats, alkoxylated animal oils, alkoxylated animal fats, and mixtures thereof.

16. The composition according to one or more of embodiments 13 to 15, wherein the at least one non-ionic surfactant is selected from alkylphenol ethoxylate formaldehyde resins, castor oil ethoxylates, and mixtures thereof.

17. The composition according to one or more of embodiments 13 to 16, wherein the alkylphenol ethoxylate formaldehyde resins is selected from butylphenol ethoxylate formadehyde resin, amylphenol ethoxylate formadehyde resin, octylphenol ethoxylate formaldehyde resin, and nonylphenol ethoxylate formaldehyde resin.

18. The composition according to one or more of embodiments 13 to 17, wherein the alkylphenol ethoxylate formaldehyde resins is selected from nonylphenol ethoxylate formaldehyde resin and amylphenol ethoxylate formaldehyde resin.

19. The composition according to one or more of embodiments 1 to 18, further comprising hydrophobic silica particles, hydrophilic silica particles, and mixtures thereof.

20. The composition according to one or more of embodiments 1 to 19, wherein the at least one first additive is present in an amount of 10 ppm to 2000 ppm by weight, based on the total weight of the composition.

21. The composition according to one or more of embodiments 1 to 20, wherein the at least one first additive is present in an amount of 20 ppm to 1500 ppm by weight, based on the total weight of the composition.

22. The composition according to one or more of embodiments 1 to 21, wherein the at least one anionic surfactant of formula (I) is present in an amount of 30 ppm to 1000 ppm by weight, based on the total weight of the at least one first additive.

23. The composition according to one or more of embodiments 1 to 22, wherein the at least one anionic surfactant of formula (I) is present in an amount of 50 ppm to 900 ppm by weight, based on the total weight of the at least one first additive.

24. The composition according to one or more of embodiments 1 to 23, wherein the at least one anionic surfactant of formula (I) is present in an amount of 100 ppm to 800 ppm by weight, based on the total weight of the at least one first additive.

25. The composition according to one or more of embodiments 1 to 24, wherein the at least one anionic surfactant of formula (I) is present in an amount of 100 ppm to 500 ppm by weight, based on the total weight of the at least one first additive.

26. The composition according to one or more of embodiments 1 to 25, wherein the weight ratio of the at least one anionic surfactant of formula (I) to the at least one polyethoxylated sorbitan ester of general formula (II) is in a range of 0.2:10 to 10:0.2.

27. The composition according to one or more of embodiments 1 to 26, wherein the weight ratio of the at least one anionic surfactant of formula (I) to the at least one polyethoxylated sorbitan ester of general formula (II) is in a range from 0.5:5 to 5:0.5.

28. The composition according to one or more of embodiments 1 to 27, wherein the weight ratio of the at least one first additive to the at least one second additive is in a range from 0.5:10 to 10:0.5.

29. A method of increasing the amount of corn oil recovered from at least one product from a corn fermentation process stream comprising the steps of:
a. contacting the at least one product from the corn fermentation process stream with a first additive as defined in any one of embodiments 1 to 12 to produce a mixture;
b. centrifuging the mixture obtained in step (a); and
c. recovering corn oil from the mixture; wherein the amount of oil recovered from the mixture is greater than the amount of corn oil that would be recovered using the same process without inclusion of the first additive.

30. The method according to embodiment 29, wherein the at least one first additive is added in the step (a) to obtain Hydrophilic-Lipophilic Difference values in the range of −2 to 2.

31. The method according to embodiment 30, wherein step (a) further comprises second additive as defined in embodiments 13 to 18.

32. The method according to embodiments 29 or 30, wherein the at least one product from the corn fermentation process is selected from the group of beer, whole stillage, thin stillage, and corn syrup.

33. The method according to one or more of embodiments 29 to 32, further comprising hydrophobic silica particles, hydrophilic silica particles, and mixtures thereof.

34. Use of at least one first additive according to one or more of embodiments 1 to 13 for increasing recovery of corn oil from at least one product obtained from a corn fermentation process stream.

35. The use according to embodiment 34, wherein the at least one first additive is added to obtain Hydrophilic-Lipophilic Difference values in the range of −2 to 2.

36. The use according to embodiments 34 and 35, further comprising at least one second additive according to one or more of embodiments 14 to 18.

37. The use according to one or more of embodiments 34 to 36, further comprising hydrophobic silica particles, hydrophilic silica particles, and mixtures thereof.

38. The use according to one or more of embodiments 34 to 37, wherein the at least one product from the corn fermentation process is selected from the group of beer, whole stillage, thin stillage, and corn syrup.

The following examples illustrate the invention in greater detail. All percentages and parts are by weight, unless stated otherwise.

### EXAMPLES

### Material and Methods

### Compounds Used for Extraction of Corn Oil:

Compound 1: Sodium lauryl ether sulphate, 12 mol EO; R₁=C₁₂ alkyl, D=0, E=12, M=Na (from Formula (I))
Compound 2: Sodium lauryl sulphate (Formaldehyde resin); R₁=C₁₂ alkyl, D=0, E=0, M=Na (from Formula (I))
Compound 3: Sodium lauryl ether sulphate, 2 mol EO; R₁=C₁₂ alkyl, D=0, E=2, M=Na (from Formula (I))
Compound 4: Alkyl ether sulfate group; R₁=C₁₆₋₁₈ alkyl, D=7, E=0.1, M=Na (from Formula (I))
Compound 5: ES9397=(50%) [Ethoxylated castor oil, POE 36]+(35%) [Base catalyzed alkyl phenol resin]+(15%) Sodium lauryl sulphate (Formaldehyde resin); R₁=C₁₂ alkyl, D=0, E=0, M=Na (from Formula (I))
Compound 6: Polysorbate 80 (20 mol EO of sorbitan monooleate); Polyoxyethylene (20) Sorbitan Monooleate
Compound 7: polysorbate 80 with hydrophobic silica; Polyoxyethylene (20) Sorbitan Monooleate with hydrophobic silica

### Method for Extraction of Corn Oil:

The below examples tests and compares the oil removal between conventional oil removal surfactant compositions and compositions with extended surfactants. The testing added desired quantity of surfactants mentioned in below tables 1 to 6 and corn syrup to four/five beakers. The mixture was stirred and heated to 90° C. before being poured into centrifuge tubes and centrifuged at 600-800 rpm for 4 minutes. The amount of recovered oil was then recorded. Results are provided below in Tables 1 to 6.

TABLE 1
Evaluation of compounds 1 to 4 at 100 ppm in improving
compound 6's performance in corn oil recovery.

| | | | | Recovered | | | |
|---|---|---|---|---|---|---|---|
| | | | | corn oil | | | |
| | | | | height | | Recovered | |
| | | Surfactant | Compound | (Scale) | | corn oil wt. | Total wt. |
| Sample | Surfactant | wt. (g) | 6 wt. (g) | (1) | (2) | (g) | (g) |
| 1 | Compound 1 | 0.0231 | 0.0351 | 31 | 31 | 2.9806 | 110.13 |
| 2 | Compound 2 | 0.0233 | 0.0355 | 28 | 28 | 2.7137 | 110.29 |
| 3 | Compound 3 | 0.0249 | 0.0352 | 30 | 30 | 2.7385 | 110.27 |
| 4 | Compound 4 | 0.139 | 0.0354 | 44 | 44 | 3.9619 | 110.08 |

Samples:
1. Compound 1 (100 ppm) + Compound 6 (500 ppm)
2. Compound 2 (100 ppm) + Compound 6 (500 ppm)
3. Compound 3 (100 ppm) + Compound 6 (500 ppm)
4. Compound 4 (100 ppm) + Compound 6 (500 ppm)

TABLE 2
Evaluation of compound 4 in improving compound
6's performance in corn oil recovery

| | | | Recovered | | | |
|---|---|---|---|---|---|---|
| | | | corn oil | Recovered | | |
| | Compound | Compound | height | corn oil | Total wt. | Tube |
| Sample | 4 wt. (g) | 6 wt. (g) | (Scale) | wt. (g) | (g) | wt. (g) |
| 1 | 0.0129 | 0.0351 | 46 | 3.9925 | 110.47 | 51.04 |
| 2 | 0.0309 | 0.0354 | 48 | 4.0928 | 110.08 | 51.05 |
| 3 | 0.0613 | 0.0355 | 46 | 3.8668 | 110.53 | 51.10 |
| 4 | 0.1097 | 0.0358 | 10 | 1.4176 | 110.29 | 51.12 |

Samples:
1. Compound 4 (100 ppm) + Compound 6 (500 ppm)
2. Compound 4 (250 ppm) + Compound 6 (500 ppm)
3. Compound 4 (500 ppm) + Compound 6 (500 ppm)
4. Compound 4 (1000 ppm) + Compound 6 (500 ppm)

TABLE 3
Evaluation of compound 4 in improving compound
6's performance in corn oil recovery

| | | | Recovered | | | |
|---|---|---|---|---|---|---|
| | | | corn oil | Recovered | | |
| | Compound | Compound | height | corn oil wt. | Total wt. | Tube wt. |
| Sample | 4 wt. (g) | 6 wt. (g) | (Scale) | (g) | (g) | (g) |
| 1 | 0.0127 | 0.0357 | 45 | 3.9204 | 110.17 | 51.05 |
| 2 | 0.0311 | 0.0352 | 48 | 4.1144 | 110.23 | 51.06 |
| 3 | 0.0618 | 0.0354 | 46 | 3.9404 | 110.49 | 51.12 |
| 4 | 0.1101 | 0.0355 | 11 | 1.6048 | 110.53 | 51.14 |

Samples:
1. Compound 4 (100 ppm) + Compound 6 (500 ppm)
2. Compound 4 (250 ppm) + Compound 6 (500 ppm)
3. Compound 4 (500 ppm) + Compound 6 (500 ppm)
4. Compound 4 (1000 ppm) + Compound 6 (500 ppm)

TABLE 4
Evaluation of compound 4 in improving compound 5's performance in corn oil recovery

| | | | | Recovered | | Recovered | |
|---|---|---|---|---|---|---|---|
| | | | | corn oil | Recovered | corn oil | Recovered |
| | Compound | Compound | Total | height - 1 | corn oil -1 | height - 2 | corn oil -2 |
| Sample | 4 wt. (g) | 5 wt. (g) | wt. (g) | (Scale) | wt. (g) | (Scale) | wt. (g) |
| 1 | 0.0301 | 0.0356 | 110.17 | 46 | 4.0912 | 1 | 0.0149 |
| 2 | 0.0303 | 0.0357 | 110.09 | 48 | 4.3703 | 1 | 0.0117 |
| 3 | 0.0609 | 0.0351 | 110.03 | 38 | 3.4318 | 1 | 0.0198 |
| 4 | 0.0602 | 0.0354 | 110.24 | 37 | 3.2742 | 1 | 0.0093 |

Samples:
1. Compound 4 (250 ppm) + Compound 5 (500 ppm)
2. Compound 4 (500 ppm) + Compound 5 (500 ppm)
3. Compound 4 (250 ppm) + Compound 5 (500 ppm)
4. Compound 4 (500 ppm) + Compound 5 (500 ppm)

From tables 1 to 4, it is evident that the use of blend comprising at least one first additive i.e., compound 4 and compound 6 performed better than blend having any other surfactant and compound 6.

TABLE 5

| | | | | | Recovered | | | |
|---|---|---|---|---|---|---|---|---|
| | Compound | Compound | Compound | Compound | corn oil | Recovered | | Tube |
| | 4 wt. | 5 | 6 wt. | 7 | height | corn oil | Total | wt. |
| Sample | (g) | wt. (g) | (g) | wt. (g) | (Scale) | wt. (g) | wt. (g) | (g) |
| 1 | 0.0308 | 0.0384 | 0 | 0 | 48 | 3.6 | 110.13 | 51.05 |
| 2 | 0.0309 | 0 | 0.0357 | 0 | 50 | 3.8 | 110.17 | 51.06 |
| 3 | 0 | 0 | 0 | 0.0354 | 51 | 4.7 | 110.29 | 51.17 |
| 4 | 0 | 0.0384 | 0 | 0 | 24 | 2.2 | 110.34 | 51.14 |

Samples:
1. Compound 4 (250 ppm) + Compound 5 (500 ppm; no silica)
2. Compound 4 (250 ppm) + Compound 6 (500 ppm)
3. Compound 7 (500 ppm)
4. Compound 5 (500 ppm; no silica, control for Sample 1)

From table 5, it is evident that the use of at least one first additive significantly improves oil yield approaching results of benchmark silica containing surfactants.

1. A composition comprising
A. at least one product from a corn fermentation process stream; and
B. at least one first additive comprising:
i. at least one anionic surfactant of formula (I)
R₁O(D)ₚ(E)_{q}SO₃⁻M⁺ (I)
wherein
R₁ is linear or branched, unsubstituted C₆-C₂₂ alkyl,
D denotes CH(CH₃)—CH₂—O—,
E denotes CH₂—CH₂—O—,
p is an integer in the range from 0 to 10,
q is an integer in the range from 0 to 35, and
M is H or alkali metal or ammonium cation; and/or
ii. at least one polyethoxylated sorbitan ester of general formula (II) 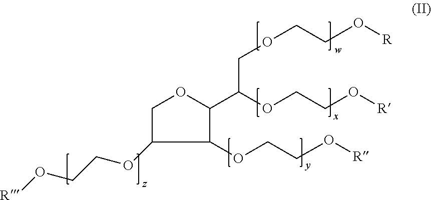
wherein
R, R′, R″, R″′ are each independently H or COR₂ with a proviso that at least one of R, R′, R″ and R″′ is not H,
R₂ is linear or branched, substituted or unsubstituted C₆ to C₂₀ alkyl or alkenyl, and
w, x, y, z is independently an integer in the range of 0 to 30,
wherein the sum of w+x+y+z is at least 5.

2. The composition according to claim 1, wherein the at least one product from a corn fermentation process stream is selected from the group consisting of beer, whole stillage, thin stillage, and corn syrup.

3. The composition according to claim 1, wherein R₁ is selected from the group consisting of n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, and 2-ethyl hexyl.

4. The composition according to claim 1, wherein R₁ denotes linear or branched, unsubstituted C₈-C₂₂ alkyl, p is an integer in the range of 1 to 10, q is an integer in the range of 0.1 to 5, and M is H or alkali metal or ammonium cation.

5. The composition according to claim 1, wherein R₁ denotes linear or branched, unsubstituted C₈-C₁₅ alkyl, p is 0, q is an integer in the range of 0.1 to 12, and M is H or alkali metal or ammonium cation.

6. The composition according to claim 1, wherein R₁ denotes linear or branched, unsubstituted C₁₂ alkyl, p is 0, q is 2, and M is alkali metal.

7. The composition according to claim 1, wherein R₁ denotes linear or branched, unsubstituted C₁₂ alkyl, p is 0, q is 12, and M is alkali metal.

8. The composition according to claim 1, wherein R₁ denotes linear, unsubstituted C₁₂ alkyl, p is 0, q is 0, and M is alkali metal.

9. The composition according to claim 1, wherein the alkali metal is selected from the group consisting of sodium and potassium.

10. The composition according to claim 1, wherein the alkali metal is sodium.

11. The composition according to claim 1, wherein the at least one polyethoxylated sorbitan ester of general formula (II) is selected from the group consisting of sorbitan monooleate ethoxylate, sorbitan tristearate ethoxylate, and mixtures thereof.

12. The composition according to claim 1, wherein the sum of w+x+y+z is 20.

13. The composition according to claim 1, further comprises at least one second additive comprising at least one anionic surfactant, other than anionic surfactant of formula (I), and/or at least one non-ionic surfactant.

14. The composition according to claim 13, wherein the at least one anionic surfactant, other than anionic surfactant of formula (I), is selected from the group consisting of alkylbenzene sulfonates, alkylphenol ether sulfates, alkyl sulfates, carboxylates, napthalene sulfonates, olefin sulfonates, petroleum sulfonates, phosphates, phospholipid, soap, soap substitute, sulfates, sulfonates, and mixtures thereof.

15. The composition according to claim 13, wherein the at least one non-ionic surfactant is selected from the group consisting of alkyl phenol resins, alkylphenol ethoxylate formaldehyde resins, alcohol alkoxylates, alkylpolyalkyleneoxides, alkylpolyglucosides, block copolymers of ethylene oxide and propylene oxide, block copolymers of ethylene oxide and butylene oxide, carboxylic amides, carboxylic esters, castor oil ethoxylates, fatty alcohols, glycol esters of fatty acids, sorbitan esters, monoalkanolamine condensates, polyethylene glycol esters, polyoxyethylenes, polyoxyethylene fatty acid amides, fatty esters of alkoxylated glycerols, alkoxylated plant oils, alkoxylated plant fats, alkoxylated animal oils, alkoxylated animal fats, and mixtures thereof.

16. The composition according to claim 13, wherein the at least one non-ionic surfactant is selected from the group consisting of alkylphenol ethoxylate formaldehyde resins, castor oil ethoxylates, sorbitan esters, and mixtures thereof.

17. The composition according to claim 13, wherein the alkylphenol ethoxylate formaldehyde resins is selected from the group consisting of butylphenol ethoxylate formadehyde resin, amylphenol ethoxylate formadehyde resin, octylphenol ethoxylate formaldehyde resin, and nonylphenol ethoxylate formaldehyde resin.

18. The composition according to claim 13, wherein the alkylphenol ethoxylate formaldehyde resins is selected from the group consisting of nonylphenol ethoxylate formaldehyde resin and amylphenol ethoxylate formaldehyde resin.

19. The composition according to claim 1, further comprising hydrophobic silica particles, hydrophilic silica particles, and mixtures thereof.

20. The composition according to claim 1, wherein the at least one first additive is present in an amount of 10 ppm to 2000 ppm by weight, based on the total weight of the composition.

21. The composition according to claim 1, wherein the at least one first additive is present in an amount of 20 ppm to 1500 ppm by weight, based on the total weight of the composition.

22. The composition according to claim 1, wherein the at least one anionic surfactant of formula (I) is present in an amount of 30 ppm to 1000 ppm by weight, based on the total weight of the at least one first additive.

23. The composition according to claim 1, wherein the at least one anionic surfactant of formula (I) is present in an amount of 50 ppm to 900 ppm by weight, based on the total weight of the at least one first additive.

24. The composition according to claim 1, wherein the at least one anionic surfactant of formula (I) is present in an amount of 100 ppm to 800 ppm by weight, based on the total weight of the at least one first additive.

25. The composition according to claim 1, wherein the at least one anionic surfactant of formula (I) is present in an amount of 100 ppm to 500 ppm by weight, based on the total weight of the at least one first additive.

26. The composition according to claim 1, wherein the weight ratio of the at least one anionic surfactant of formula (I) to the at least one polyethoxylated sorbitan ester of general formula (II) is in a range of 0.2:10 to 10:0.2.

27. The composition according to claim 1, wherein the weight ratio of the at least one anionic surfactant of formula (I) to the at least one polyethoxylated sorbitan ester of general formula (II) is in a range from 0.5:5 to 5:0.5.

28. The composition according to claim 1, wherein the weight ratio of the at least one first additive to the at least one second additive is in a range from 0.5:10 to 10:0.5.

29. A method of increasing the amount of corn oil recovered from at least one product from a corn fermentation process stream comprising the steps of:
a. contacting the at least one product from the corn fermentation process stream with a first additive as defined in claim 1 to produce a mixture;
b. centrifuging the mixture obtained in step (a); and
c. recovering corn oil from the mixture; wherein the amount of oil recovered from the mixture is greater than the amount of corn oil that would be recovered using the same process without inclusion of the first additive.

30. The method according to claim 29, wherein step (a) further comprises second additive comprising at least one anionic surfactant, other than anionic surfactant of formula (I), and/or at least one non-ionic surfactant.

31. The method according to claim 29, wherein the at least one product from the corn fermentation process is selected from the group consisting of beer, whole stillage, thin stillage, and corn syrup.

32. The method according to claim 29, further comprising hydrophobic silica particles, hydrophilic silica particles, and mixtures thereof.

33. A method of using the at least one first additive according to claim 1, the method comprising using the at least one first additive for increasing recovery of corn oil from at least one product obtained from a corn fermentation process stream.

34. The method of use according to claim 34, further comprising using at least one second additive comprising at least one anionic surfactant, other than anionic surfactant of formula (I), and/or at least one non-ionic surfactant.

35. The method of use according to claim 33, further comprising hydrophobic silica particles, hydrophilic silica particles, and mixtures thereof.

36. The method of use according to claim 33, wherein the at least one product from the corn fermentation process is selected from the group consisting of beer, whole stillage, thin stillage, and corn syrup.
